(19) United States
(12) Patent Application Publication
(10) Pub. No.: US 2009/0231219 A1
(43) Pub. Date: Sep. 17, 2009

(54) Antenna device for vehicle

(75) Inventors: Yuzi Sugimoto, Kariya-city (JP); Mitsuru Fujita, Toyohashi-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/381,751

(22) Filed: Mar. 16, 2009

(30) Foreign Application Priority Data
Mar. 17, 2008 (JP) 2008-067651

(51) Int. Cl. H01Q 1/32; H01Q 1/36; H01Q 21/06

(52) U.S. Cl. 343/713; 343/700 MS; 343/853

(57) ABSTRACT

In an antenna device, first and second vertically-polarized antennas are disposed at respective horizontal end portions of a substrate. A first ground pattern functioning as a ground plane of the first antenna and a second ground pattern function as a ground plane of the second antenna are disposed on the substrate. An intermediate pattern is located between the first ground pattern and the second ground pattern and functions as a horizontally-polarized non-feed element for the first antenna and the second antenna. The phase control part controls a phase difference between a signal of the first antenna and a signal of the second antenna by changing at least one of a phase of the signal of the first antenna and a phase of the signal of the second antenna. The combining portion combines the signals after the phase control part controls the phase deference.

### CROSS REFERENCE TO RELATED APPLICATIONS

The present application is based on and claims priority to Japanese Patent Application No. 2008-67651 filed on Mar. 17, 2008, the contents of which are incorporated in their entirety herein by reference.

### BACKGROUND OF THE INVENTION

1. Field of the Invention

The present invention relates to an antenna device for a vehicle.

2. Description of the Related Art

Conventionally, an inter-vehicle communication system and a road-to-vehicle communication system are known. In the inter-vehicle communication system, the vehicle transmits and receives information about an actual location, a speed, and a running direction with another vehicle for preventing a collision with each other. In the road-to-vehicle system including an electric toll collection system (ETC system) and a vehicle information and communication system (VICS), the vehicle communicates with an apparatus placed in the vicinity of a road.

An antenna used for the above-described systems can be disposed on a roof of the vehicle or on a dashboard of the vehicle. Alternatively, the antenna can be built in a room mirror for securing a space of a vehicle interior and improving an appearance. In a case where the antenna is built in the room mirror, a direction of the antenna is changed when a direction of the room mirror is changed. Thus, a stable communication is difficult to be secured.

JP-A-2006-279881 discloses a room mirror with a phased array antenna. A directivity of the phased array antenna is adjusted in accordance with an angle of the room mirror. US 2003/0090820A (corresponding to JP-A-2003-146136) discloses a room mirror with a built-in antenna. When an angle of the room mirror is changed, an angle of the antenna is changed by a gear so that an angle of the antenna with respect to a vehicle is unchanged.

A polarization plane of a radio wave transmitted from a transmitting side may be changed until the radio wave reaches a receiving side due to a communication environment, for example, an existence of a reflecting object. Thus, when a vertically-polarized wave is transmitted from the transmitting side, the polarization plane of the radio wave received by the receiving side may be different from the vertically-polarized wave, for example, a horizontally-polarized wave.

When the polarization plane is changed, a sensitivity and a gain of a receiving antenna may be reduced. Thus, a receiving performance may be reduced. In a method disclosed in JP-A-2006-279881, the directivity can be changed by using the phased array antenna. However, the phased array antenna cannot respond to a change in the polarization plane. Thus, a stable communication may be difficult to be secured depending on the communication environment.

Therefore, an antenna device is required to have a high receiving performance even when a polarization plane of a radio wave is changed in addition to adjust a directivity.

### SUMMARY OF THE INVENTION

In view of the foregoing problems, it is an object of the present invention to provide an antenna device for a vehicle.

An antenna device for a vehicle according to an aspect of the present invention includes a substrate, a first antenna, a second antenna, a first ground pattern, a second ground pattern, an intermediate pattern, a phase control part, and a combining portion. The substrate extends in an approximately horizontal direction. The first antenna and the second antenna are disposed at respective horizontal end portions of the substrate. Each of the first antenna and the second antenna is a vertically-polarized antenna. The first ground pattern and the second ground pattern are disposed on the substrate. The first ground pattern functions as a ground plane of the first antenna and the second ground pattern functions as a ground plane of the second antenna. The intermediate pattern is disposed on the substrate and is located between the first ground pattern and the second ground pattern. The intermediate pattern functions as a horizontally-polarized non-feed element for the first antenna and the second antenna. The phase control part controls a phase difference between a signal of the first antenna and a signal of the second antenna by changing at least one of a phase of the signal of the first antenna and a phase of the signal of the second antenna. The combining portion combines the signals after the phase control part controls the phase deference. The present antenna device can have a high receiving performance even if an arrival direction and a polarization plane of a received signal are changed.

An antenna device for a vehicle according to another aspect of the present invention includes a first antenna, a second antenna, an intermediate conductive member, a phase control part, and a combining portion. The first antenna and a second antenna are disposed apart from each other in an approximately horizontal direction. Each of the first antenna and the second antenna is a vertically-polarized antenna. The intermediate conductive member is disposed between the first antenna and the second antenna. The intermediate conductive member functions as a horizontally-polarized non-feed element for the first antenna and the second antenna. The phase control part controls a phase difference between a signal of the first antenna and a signal of the second antenna by changing at least one of a phase the signal of the first antenna and a phase of the signal of the second antenna. The combining portion is configured to combine the signals after the phase control part controls the phase deference. The present antenna device can have a high receiving performance even if an arrival direction and a polarization plane of a received signal are changed.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a diagram illustrating a room mirror including an antenna device according to a first embodiment of the present invention;

FIG. 2 is a diagram illustrating a rear surface of a substrate of the antenna device;

FIG. 3 is a diagram illustrating a relationship between a phase difference of two antennas and a directivity of the antenna device;

FIG. 4 is a graph illustrating a relationship between the phase difference of the two antennas and an angle of a peak gain;

FIG. 5 is a graph illustrating a relationship between the phase difference of the two antennas and the peak gain;

FIG. 6 is a diagram illustrating the peak gain and the angle of the peak gain with respect to the phase difference of the two antennas;

FIG. 7 is a diagram illustrating a room mirror including an antenna device according to a second embodiment of the present invention;

FIG. 8A is a cross-sectional view illustrating the room mirror including the antenna device according to the second embodiment and FIG. 8B is a front view of the antenna device;

FIG. 9 is a diagram illustrating a directivity of horizontally-polarized wave in a case where a phase difference of two antennas is 180 degree;

FIG. 10 is a diagram illustrating a room mirror including an antenna device according to a modification; and

FIG. 11 is a diagram illustrating an inverted L-shaped antenna.

### DETAILED DESCRIPTION OF THE PREFERRED EMBODIMENTS

### First Embodiment

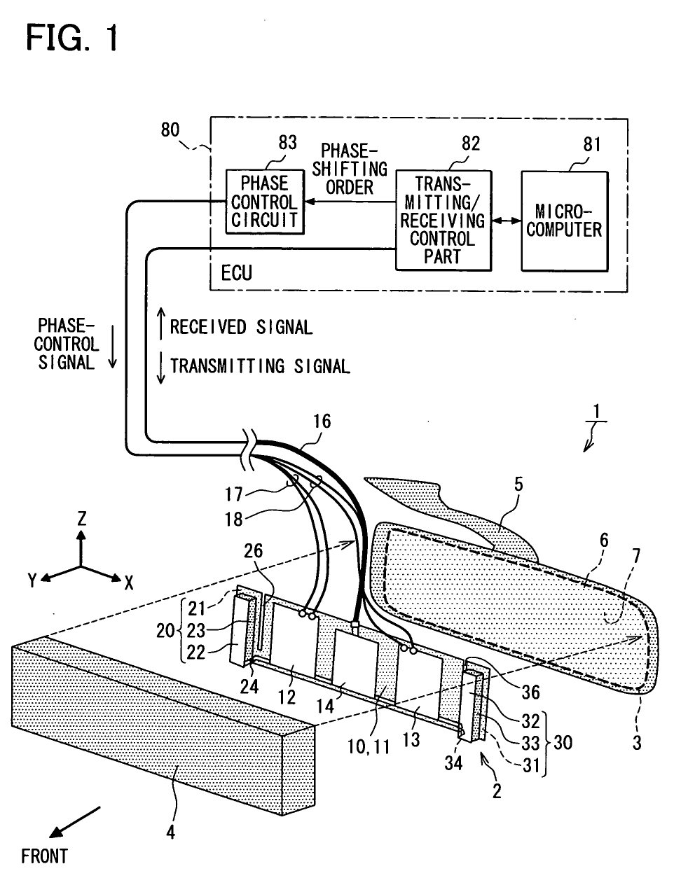

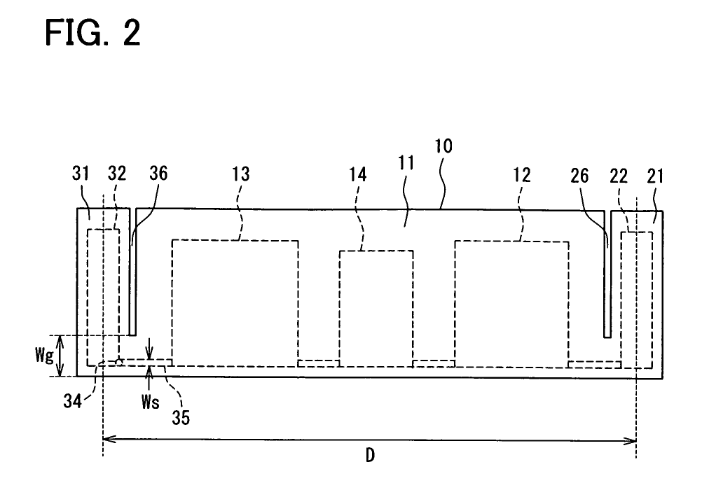

An antenna device 2 according to a first embodiment of the present invention will be described with reference to FIG. 1 and FIG. 2. The antenna device 2 is built in a room mirror 1. The room mirror 1 is provided in a front upper portion of a vehicle interior. The room mirror 1 is used by a user of a vehicle for seeing the vehicle interior and an outside of the vehicle. The room mirror 1 includes a mirror housing 3, a mirror body 6 fitted in the mirror housing 3, and a resin cover 4 covering the mirror housing 3. The antenna device 2 is disposed in the mirror housing 3.

On a front surface of the mirror body 6, a metal film 7 is formed for reflecting light. On a rear surface of the mirror body 6, a mirror plane is formed. The mirror body 6 is fitted in the mirror housing 3 in such a manner that the rear surface is exposed from the mirror housing 3 toward a rear side of the vehicle. Thus, the metal film 7 of the mirror body 6 is located inside of the mirror housing 3. The mirror housing 3 is fixed to a ceiling of the vehicle interior through a supporting member 5.

The antenna device 2 can be used for an inter-vehicle communication and a road-to-vehicle communication. The antenna device 2 is configured to transmit and receive a radio wave having a frequency band of 700 MHz, for example.

The antenna device 2 includes a substrate 10. The substrate 10 is disposed in the mirror housing 3 in such a manner that a plane surface of the substrate 10 is approximately vertical to a ground and is approximately parallel to the mirror body 6 and metal film 7. The substrate 10 is apart from the metal film 7 of the mirror body 6. For example, a distance between the substrate 10 and the metal film 7 is about a quarter of a wavelength λ corresponding to a communication frequency. In the present embodiment, the communication frequency band is 700 MHz.

The substrate 10 extends in an approximately horizontal direction. A horizontal length of the substrate 10 is substantially similar to a horizontal length of the mirror body 6. At respective horizontal end portions of a front surface of the substrate 10, a first antenna 20 and a second antenna 30 are disposed.

The first antenna 20 is an inverted F antenna having a plate shape. The first antenna 20 is disposed on a right end portion of the substrate 10. The first antenna 20 includes an antenna element 22 and a ground plane 21. Between the ground plane 21 and the antenna element 22, a dielectric member 23 having a predetermined permittivity is disposed. The antenna element 22 includes a rising part, an extending part, and a shorted part. The rising part rises from a feeding point 24 approximately vertically to the ground plane 21. The extending part extends from an end portion of the rising part approximately parallel to the ground plane 21, that is, approximately vertically to the ground. The shorted part falls approximately vertically from a part of a lower side of the extending part to the ground plane 21. An end of the shorted part is shorted to the ground plane 21. The shorted part is not illustrated in FIG. 1. The shorted part can be seen when the antenna device 2 is seen from a lower side. The ground plane 21 is disposed on a rear surface of the substrate 10.

The second antenna 30 is an inverted F antenna having a plate shape. The second antenna 30 is disposed on a left end portion of the substrate 10. The second antenna 30 includes an antenna element 32 and a ground plane 31. Between the ground plane 31 and the antenna element 32, a dielectric member 33 having a predetermined permittivity is disposed. The antenna element 32 includes a rising part, an extending part, and a shorted part. The rising part rises from a feeding point 34 approximately vertically to the ground plane 31. The extending part extends from an end portion of the rising part approximately parallel to the ground plane 31, that is, approximately vertically to the ground. The shorted part falls approximately vertically from a part of a lower side of the extending part to the ground plane 31. An end of the shorted part is shorted to the ground plane 31. The shorted part is not illustrated in FIG. 1. The shorted part can be seen when the antenna device 2 is seen from a lower side. The ground plane 31 is disposed on the rear surface of the substrate 10.

Each of the first antenna 20 and the second antenna 30 is a vertically-polarized wave antenna that transmits and receives a vertically-polarized wave strongly. A property of the first antenna 20 is substantially similar to a property of the second antenna 30.

The substrate 10 is not required to be disposed strictly vertically to the ground. The substrate 10 may be disposed approximately vertically to the ground so that the first antenna 20 and the second antenna 30 can provide a desired performance. Similarly, in the above-described positional relationships between each of the antenna elements 22 and 23 and the substrate 10, it is not required to be strictly vertical or strictly parallel. The positional relationships may be approximately vertical or approximately parallel so that the first antenna 20 and the second antenna 30 can provide the desired performance.

Between the first antenna 20 and the second antenna 30, two phase shifters 12 and 13 and a combiner/distributor 14 are formed on the front surface of the substrate 10 by microstrip lines. A feeding line between each of the phase shifters 12 and 13 and the combiner/distributor 14 and a feeding line between each of the phase shifters 12 and 13 and corresponding one of the feeding points 24 and 34 are formed by microstrip lines.

The phase shifter 12 is coupled with the feeding point 24 of the first antenna 20. The phase shifter 12 shifts a phase of a signal received by the first antenna 20 or a phase of a signal transmitted from the first antenna 20. The phase shifter 12 is a variable phase shifter. A phase shifting amount of the phase shifter 12 is changed in accordance with the phase-control signal transmitted from an electronic control unit (ECU) 80 through a transmission cable 17. The ECU 80 is provided aside from the room mirror 1.

The phase shifter 13 is coupled with the feeding point 34 of the second antenna 30. The phase shifter 13 shifts a phase of a signal received by the second antenna 30 or a phase of a signal transmitted from the second antenna 30. The phase shifter 13 is a variable phase shifter. A phase shifting amount of the phase shifter 13 is changed in accordance with the phase-control signal transmitted from the ECU 80 through a transmission cable 18.

Each of the phase shifters 12 and 13 may be a hybrid phase shifter (reflective variable phase shifter) including a hybrid coupler and a variable-capacitance element. The ECU 80 can be disposed in any position in the vehicle. For example, the ECU 80 may be disposed in the dashboard. The ECU 80 executes various controls of the inter-vehicle communication and the road-to-vehicle communication. The ECU 80 includes a microcomputer 81, a transmitting/receiving control part 82, and a phase control circuit 83. The microcomputer 81 controls the transmitting/receiving control part 82. The transmitting/receiving control part 82 controls a transmitting and receiving of a signal at the antenna device 2. The phase control circuit 83 outputs a phase-control signal to the phase shifters 12 and 13 based on a phase-shifting order from the transmitting/receiving control part 82. The ECU 80 can include various elements including a hardware and a software although only main components related to the antenna device 2 are illustrated in FIG. 1.

The phase control circuit 83 outputs the phase-control signal to the phase shifters 12 and 13 for changing a phase-shifting amount of each of the phase shifters 12 and 13. Thereby, a phase difference of the received signals of the first antenna 20 and the second antenna 30 and a phase difference of the transmitting signals from the first antenna 20 and the second antenna 30 can be a predetermined value. The phase control circuit 83 may be disposed in the room mirror 1, for example, on the substrate 10.

The received signal of the first antenna 20 is phase-shifted at the phase shifter 12. The received signal of the second antenna 30 is phase-shifted at the phase shifter 13. The combiner/distributor 14 combines the phase-shifted received signals and transmits the combined signal to a communication device (not shown) through a coaxial cable 16. In addition, the combiner/distributor 14 equally distributes a signal transmitted from the communication device through the coaxial cable 16 to the phase shifters 12 and 13.

On the rear surface of the substrate 10, the ground plane 21 of the first antenna 20, the ground plane 31 of the second antenna 30, and a circuit ground 11 are disposed, as shown in FIG. 2. The circuit ground 11 can function as a common ground of the phase shifters 12 and 13 and the combiner/distributor 14. The ground planes 21 and 31 and the circuit ground 11 are physically-connected with each other and are made of one electric conductive film. The substrate 10 has a slit 26 between the ground plane 21 and the circuit ground 11. In addition, the substrate 10 has a slit 36 between the circuit ground 11 and the ground plane 31. Thus, the ground plane 21 and the ground plane 31 are apart from the circuit ground 11 at a predetermined region.

The slit 36 is provided in approximately vertical direction of the substrate 10 in such a manner that a feeding ground width Wg remains from a lower end of the substrate 10. A feeding line 35 extends from the phase shifter 13 to the feeding point 34 of the second antenna 30. The feeding ground width Wg is greater than or equal to three times a line width Ws of the feeding line 35, for example. When the feeding ground width Wg is greater than or equal to three times the line width Ws of the feeding line 35, a performance of the feeding line 35 can be maintained with certainty. However, the feeding ground width Wg may not be greater than or equal to three times the line width Ws of the feeding line 35.

A relationship between a feeding ground width Wg and the line width Ws of the first antenna 20 is substantially similar to the relationship between the feeding ground width Wg and the width Ws of the second antenna 30. A distance between a center portion of the first antenna 20 and a center portion of the second antenna 30 is about ½λ. When the communication frequency band is 700 MHz, ½λ is about 20 cm, which is approximately equal to a length of a general room mirror. Thus, the substrate 10 can be fitted in the mirror housing 3 of the room mirror 1.

Due to the slits 26 and 36, each of the first antenna 20 and the second antenna 30 can have a high gain for the vertically-polarized wave. If the slits 26 and 36 are not provided and the substrate 10 has a simple rectangular shape, a width of each of the ground planes 21 and 31 increases with respect to a width of corresponding one of the antenna elements 22 and 32. Thus, each of the first antenna 20 and the second antenna 30 cannot have a high gain for the vertically-polarized wave.

In the antenna device 2 according to the present embodiment, the ground planes 21 and 31 are separated from the circuit ground 11 by the slits 26 and 36. Thus, the gain of each of the first antenna 20 and the second antenna 30 for the vertically-polarized wave increases.

The slits 26 and 36 may be provided by making cuts in the substrate 10. Alternatively, the silts 26 and 36 may be provided only in the electric conductive film on the rear surface of the substrate 10, for example, by etching.

In the antenna device 2 according to the present embodiment, the electric conductive film is formed on the whole area of the rear surface of the substrate 10. The electric conductive film is divided into the ground plane 21, the circuit ground 11, and the ground plane 31 by the slits 26 and 36. That is, due to the slits 26 and 36, the ground plane 21 and the ground plane 31 are apart from the circuit ground 11 at least at a region where a distance from the feeding point 24 and 34 is greater than a predetermined distance in the vertical direction. However, the ground plane 21, the circuit ground 11, and the ground plane 31 are physically and electrically connected with each other at a region corresponding to the feeding line 35, that is, a region having the feeding ground width Wg. Therefore, the ground plane 21, the circuit ground 11, and the ground plane 31 are formed of the one electric conductive film that is physically integrated and is electrically conductive.

The circuit ground 11 located between the ground planes 21 and 31 can function as the ground of the phase shifters 12 and 13 and the combiner/distributor 14. Furthermore, the circuit ground 11 can function as a horizontally-polarized non-feed element for the first antenna 20 and the second antenna 30.

When the first antenna 20 receives a radio wave or when a transmitting signal is supplied to the first antenna 20, an electric current flows in the first antenna 20. Especially, a large electric current flows to the feeding point 24. When the electric current flows in the first antenna 20, the electric current also flows in the circuit ground 11 due to an electromagnetic coupling. The electric current due to the electromagnetic coupling with the first antenna 20 (first electric current) flows in the circuit ground 11 in an approximately horizontal direction. Thereby, the circuit ground 11 can function as the horizontally-polarized non-feed element. A relationship between the second antenna 30 and the circuit ground 11 is substantially similar to the above-described relationship between the first antenna 20 and the circuit ground 11. Thus, an electric current due to the electromagnetic coupling with the second antenna 30 (second electric current) flows in the circuit ground 11 in an approximately horizontal direction.

A direction and the amount of the first electric current and the second electric current are changed in accordance with the phase difference of the received signals of the first antenna 20 and the second antenna 30 or the phase difference of the transmitting signals from the first antenna 20 and the second antenna 30.

In theory, when the phase-shifting amount of the phase shifters 12 and 13 are controlled so that the phase difference of the signals of the first antenna 20 and the second antenna 30 becomes 0 degree (same phase), the first electric current and the second electric current weaken each other. When the phase-shifting amount of the phase shifters 12 and 13 are controlled so that the phase difference of the signals of the first antenna 20 and the second antenna 30 becomes 180 degrees, the first electric current and the second electric current have approximately the same phase and flows in approximately the same direction. Thus, the first electric current and the second electric current strengthen each other. Therefore, the antenna device 2 can have a high gain for the horizontally-polarized wave.

If the circuit ground 11 is not provided in the antenna device 2 and the first antenna 20 and the second antenna 30 are apart from each other so as to have a distance D therebetween, the antenna device 2 can function as only a phased array antenna that can control a directivity of the vertically-polarized wave by controlling the phase-shifting amount of the phase shifters 12 and 13.

The antenna device 2 according to the present embodiment includes the circuit ground 11 located between the first antenna 20 and the second antenna 30. The circuit ground 11 can function as the horizontally-polarized non-feed element for the first antenna 20 and the second antenna 30. Thus, by controlling the phase difference of the signals of the first antenna 20 and the second antenna 30, the antenna device 2 can change the polarization planes of the horizontally-polarized wave and the vertically-polarized wave and can control the directivities of each of the polarized wave.

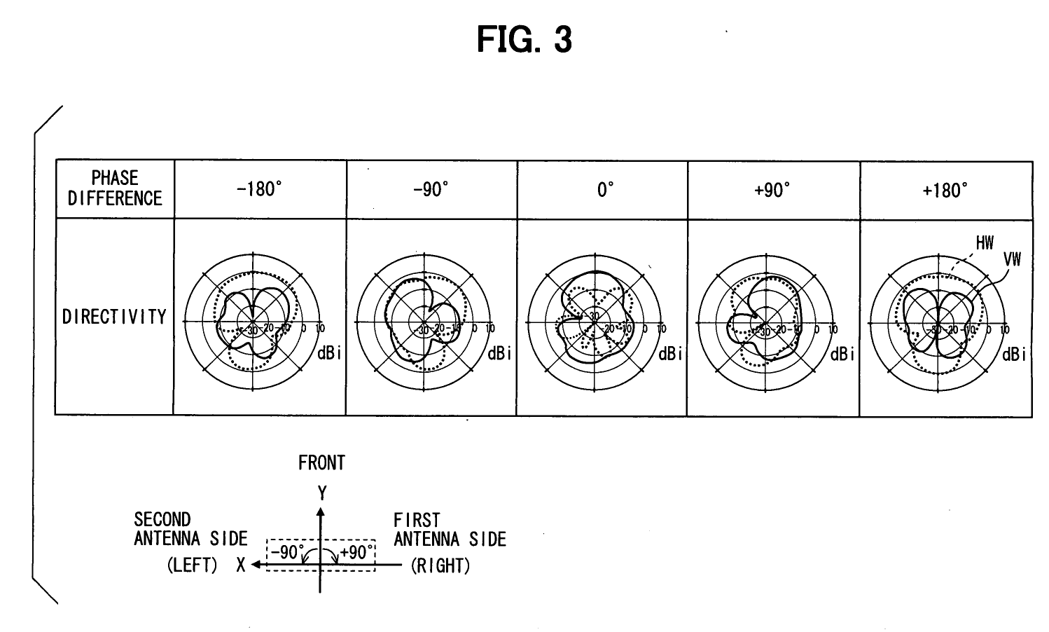

Changes in the directivities and the gains of the vertically-polarized wave and the horizontally-polarized wave when the phase difference of the received signals of the first antenna 20 and the second antenna 30 is changed will be described with reference to FIG. 3 to FIG. 6. The phase difference is changed in steps of 10 degrees or 5 degrees. The directivities and the gains of the vertically-polarized wave and the horizontally-polarized wave are measured at each of the phase differences when a radio wave of a predetermined level is received.

The directivities of the vertically-polarized wave (VW) and the horizontally-polarized wave (HW) of the received signals of the first antenna 20 and the second antenna 30 at a time when the phase difference is 0 degree, ±90 degrees, and ±180 degrees are shown in FIG. 3. The phase difference is a relative difference of the received signal of the first antenna 20 with respect to the received signal of the second antenna 30. Thus, when the phase difference is a positive value, the phase of the received signal of the first antenna 20 is ahead of the phase of the received signal of the second antenna 30.

As illustrated in FIG. 3, when the phase difference is ±180 degrees, the vertically-polarized wave does not have sufficient gain. When the phase difference is +90 degrees, the vertically-polarized wave has a sufficient peak gain to the left side of the vehicle. When the phase difference is 0 degrees, the vertically-polarized wave has a sufficient peak gain to the front side of the vehicle. When the phase difference is −90 degrees, the vertically-polarized wave has a sufficient peak gain to the right side of the vehicle.

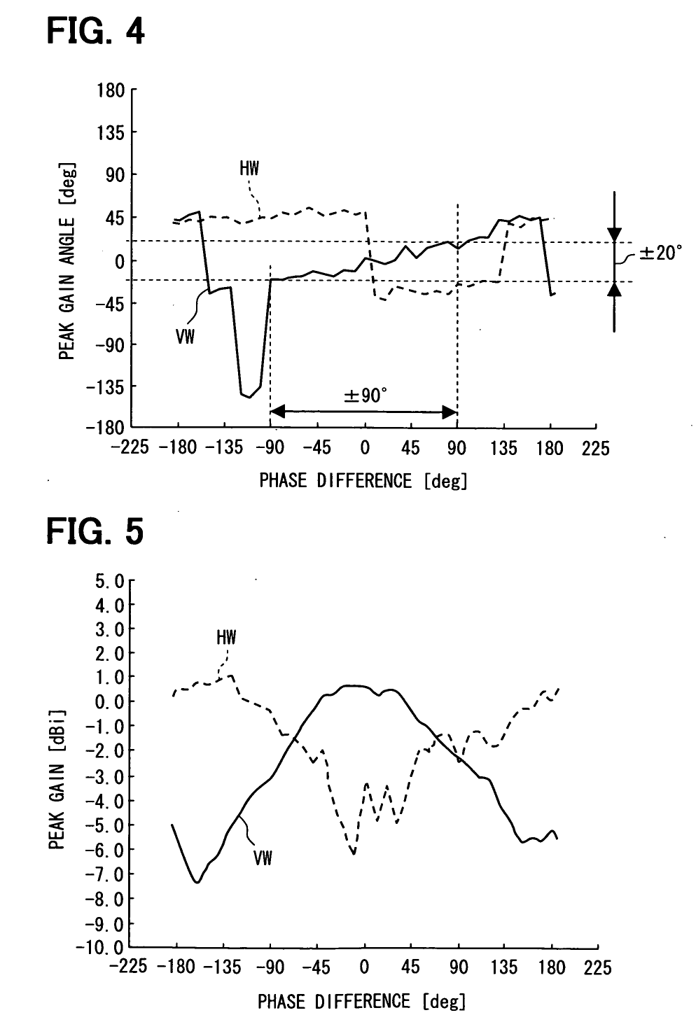

Thus, by changing the phase difference from −90 degrees to +90 degrees, a direction of the peak gain can be changed from the left side to the right side. As illustrated in FIG. 4, when the phase difference is changed from −90 degrees to +90 degrees, a peak gain angle can be changed from −20 degrees to +20 degrees. When the absolute value of the phase difference exceeds 90, the peak gain decreases under −3 dB. Thus, when the phase difference is from −90 degrees to +90 degrees, the antenna device 2 can have a high receiving performance for the vertically-polarized wave. In this range, the peak gain angle can be changed from −20 degrees to +20 degrees.

On the other hand, the horizontally-polarized wave does not have sufficient gain when the phase difference is 0 degree. When the phase difference is ±90 degrees, the horizontally-polarized wave has a sufficient peak gain. When the phase difference is ±180 degrees, the peak gain of the horizontally-polarized wave further increases. The peak gain angle of the horizontally-polarized wave does not change apparently compared with the peak gain angle of the vertically-polarized wave. When the phase difference is −90 degrees and −180 degrees, the peak gain angle of the horizontally-polarized wave is left-leaning. When the phase difference is +90 degrees and the +180 degrees, the peak gain angle of the horizontally-polarized wave is right-leaning.

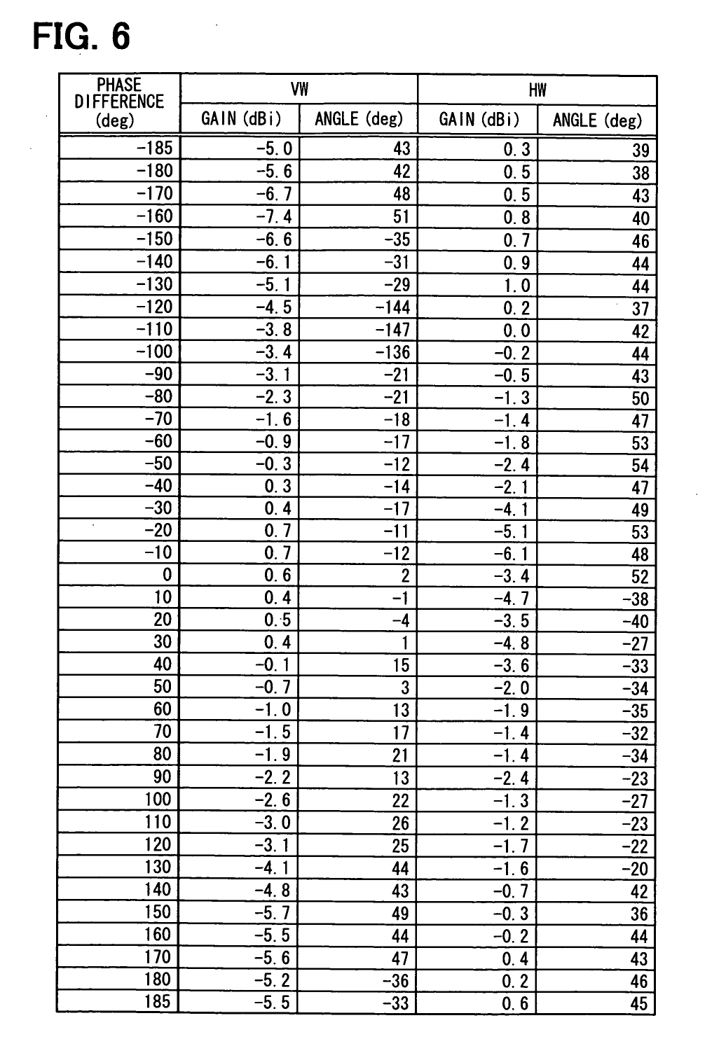

As illustrated in FIG. 4 and FIG. 6, when the phase difference is from +10 degrees to +130 degrees, the peak gain angle of the horizontally-polarized wave is about −30±10 degrees and the direction of the peak angle is the left side. When the phase difference is other than above-described range, the direction of the peak gain angle changes to the right side and the peak gain angle is about +45±10 degrees. When the absolute value of the phase difference is less than 60, the peak gain decreases under −3 dB, as illustrated in FIG. 5. Thus, when the absolute value of the phase difference is greater than or equal to 60, the antenna device 2 can have a high receiving performance for the horizontally-polarized wave.

As described above, the antenna device 2 according to the present embodiment is disposed in the room mirror 1. The antenna device 2 includes the first antenna 20 and the second antenna 30 disposed on the respective horizontal end portions of the substrate 10 and the circuit ground 11 disposed between the first antenna 20 and the second antenna 30. Each of the first antenna 20 and the second antenna 30 is the vertically-polarized antenna. The circuit ground 11 can function as the horizontally-polarized non-feed element for the first antenna 20 and the second antenna 30. The signals of the first antenna 20 and the second antenna 30 are controlled by the corresponding phase shifters 12 and 13 so that the phase difference of the signals becomes a desired value. As illustrated in FIG. 3 to FIG. 6, the polarization planes and the directivities of the horizontally-polarized wave and the vertically-polarized wave can be changed by controlling the phase difference.

Thus, even if an arrival direction and the polarization plane of the received signal are changed, the antenna device 2 can have a high receiving performance. In addition, due to a reversibility of a transmitting/receiving property of an antenna, the antenna device 2 can have similar effects at a time of transmitting signal.

On the rear surface of the substrate 10, the ground planes 21 and 31 and the circuit ground 11 are formed of the one electric conductive film. Thus, the electric conductive film can be formed easily and the gain of the horizontally-polarized wave is further improved.

The ground planes 21 and 31 are separated from the circuit ground 11 by the corresponding slits 26 and 36. Thus, the gain of the vertically-polarized wave of each of the first antenna 20 and the second antenna 30 can be improved, and thereby the gain of the vertically-polarized wave of the antenna device 2 can be improved.

On the substrate 10, the phase shifters 12 and 13 and the combiner/distributor 14 are formed of the microstrip lines in addition to the first antenna 20 and the second antenna 30. Thus, a dimension of the antenna device 2 can be reduced.

The antenna device 2 is disposed in the mirror housing 3. The substrate 10 is apart from the metal film 7 and is arranged in parallel with the metal film 7. In the present embodiment, the distance between the substrate 10 and the metal film 7 is about ¼λ. Because the antenna device 2 is disposed in the mirror housing 3, the space of the vehicle interior is not reduced. In addition, because the antenna device 2 is hidden from an outside of the room mirror 1, the appearance of the vehicle interior can be improved. The substrate 10 is disposed in the mirror housing 3 in such a manner that the rear surface of the substrate 10 faces the metal film 7 of the mirror body 6. Thus, the electric current that flows in the circuit ground 11 in the horizontal direction is increased due to a reflection by the metal film 7. Therefore, the gain of the horizontally-polarized wave of the antenna device 2 can be further improved. Even if the direction of the mirror body 6 is changed by a user of the vehicle, the antenna device 2 can control the directivity by changing the phase difference. Therefore, the antenna device 2 can have a high receiving performance regardless of the direction of the mirror body 6.

Each of the first antenna 20 and the second antenna 30 is the inverted F antenna having the plate shape. Thus, the dimension of each of the first antenna 20 and the second antenna 30 can be reduced. In addition, each of the first antenna 20 and the second antenna 30 can have a high gain of the vertically-polarized wave.

In the present embodiment, the phase control circuit 83 can function as a control-signal output portion. The phase shifters 12 and 13 can function as a phase changing portion. The combiner/distributor 14 can function as a combining portion and a distributing portion. The circuit ground 11 can function as an intermediate pattern.

### Second Embodiment

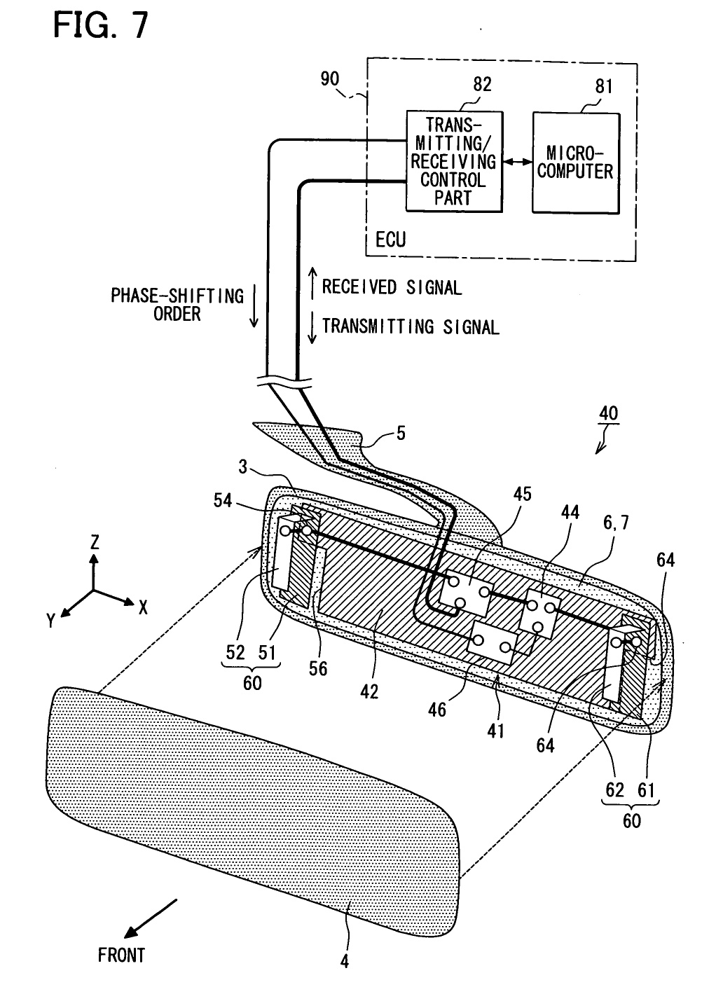

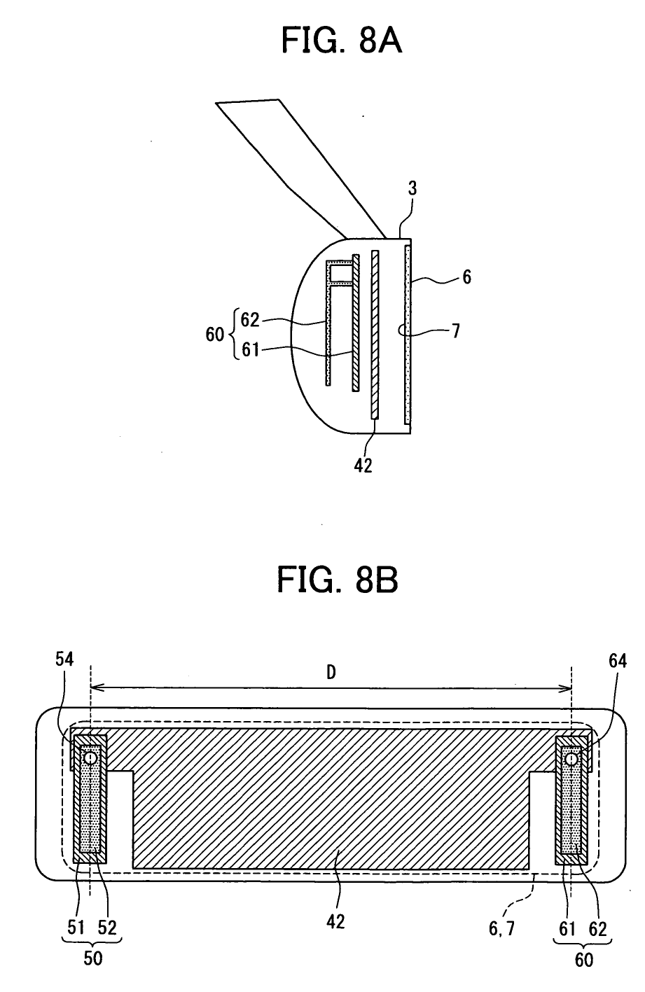

An antenna device 41 according to a second embodiment of the present invention will be described with reference to FIG. 7, FIG. 8A and FIG. 8B. The antenna device 41 is disposed in a room mirror 40. The room mirror 40 includes a mirror housing 3, a resin cover 4, a supporting member 5, and a mirror body 6 similar to those of the room mirror 1 according to the first embodiment.

The antenna device 41 includes a first antenna 50 and a second antenna 60. The first antenna 50 and the second antenna 60 are apart from each other in the approximately horizontal direction. Each of the first antenna 50 and the second antenna 60 is an inverted F antenna having a plate shape.

The first antenna 50 is disposed on the right side. The first antenna 50 includes a ground plane 51 and an antenna element 52. The second antenna 60 is disposed on the left side. The second antenna 60 includes a ground plane 61 and an antenna element 62. Each of the ground planes 51 and 61 are arranged approximately vertically to the ground. A distance D between a center portion of the first antenna 50 and a center portion of the second antenna 60 is about ½λ.

The antenna device 41 further includes a metal plate 42. The metal plate 42 is disposed between the first antenna 50 and the second antenna 60. The metal plate 42 is located on a rear-surface side of the ground planes 51 and 61. Thus, the metal plate 42 is located on an opposite side of the ground planes 51 and 61 from the antenna elements 52 and 62. The metal plate 42 can function as an intermediate conductive member. The metal plate 42 has cutout portions 56 and 66 at respective horizontal end portions.

As illustrated in FIG. 8B, the first antenna 50 faces the metal plate 42 only at a predetermined section including a feeding point 54. The other section of the first antenna 50 is located outside of the horizontal end portion of the metal plate 42. Thus, the other section of the first antenna 50 does not face the metal plate 42. The second antenna 60 faces the metal plate 42 only at a predetermined section including a feeding point 64. The other section of the second antenna 60 does not face the metal plate 42.

The metal plate 42 has the cutout portions 56 and 66 at the respective horizontal end portions so that only the predetermined sections of the first antenna 50 and the second antenna 60 adjacent to the corresponding feeding points 54 and 64 face the metal plate 42 and the other sections of the first antenna 50 and the second antenna 60 are located outside horizontal ends of the metal plate 42. Thereby, each of the first antenna 50 and the second antenna 60 can function as the vertically-polarized antenna and the metal plate 42 coupled with the first antenna 50 and the second antenna 60 can function as a horizontally-polarized non-feed element.

On a front surface of the metal plate 42, a phase shifter 44, a phase control circuit 46, and a combiner/distributor 45 are disposed between the first antenna 50 and the second antenna 60. An ECU 90 includes a microcomputer 81 and a transmitting/receiving control part 82. The phase control circuit 46 outputs a phase-control signal to the phase shifter 44 in accordance with a phase-shifting order from the transmitting/receiving control part 82.

The whole area of the metal plate 42 faces the metal film 7 of the mirror body 6, as illustrated in FIG. 8A. A distance between the metal plate 42 and the metal film 7 is about ¼λ.

In the antenna device 41 shown in FIG. 7, the ground plane 51 and the antenna element 52 of the first antenna 50 have a clearance therebetween and the ground plane 61 and the antenna element 62 of the second antenna 60 have a clearance therebetween. A dielectric member may be interposed between the ground plane 51 and the antenna element 52 and between the ground plane 61 and the antenna element 62. The phase shifter 44 and the combiner/distributor 45 may be disposed on a substrate instead of the metal plate 42. In the present case, the substrate may be formed into a shape similar to the metal plate 42 so that the substrate can function as a horizontally-polarized non-feed element.

Thus, the antenna device 41 can control the polarization planes and the directivities of the horizontally-polarized wave and the vertically-polarized wave by controlling the phase difference of the signals of the first antenna 50 and the second antenna 60 in a manner similar to the antenna device 2 according to the first embodiment. For example, the antenna device 41 can have a high gain of the vertically-polarized wave by controlling the phase difference to ±90 degrees. In addition, the antenna device 41 control the directivity, that is, the peak gain angle of the vertically-polarized wave by changing the phase difference. Furthermore, the antenna device 41 can have a high gain of the horizontally-polarized wave by controlling the phase difference to ±180 degrees and can control the directivity of the horizontally-polarized wave by changing the phase difference.

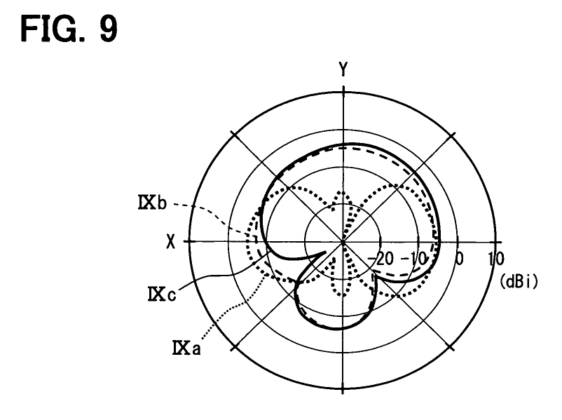

The directivity of the horizontally-polarized wave at a time when the phase shifter 44 is controlled so that the phase difference of the signals of the first antenna 50 and the second antenna 60 becomes 180 degrees will be described with reference to FIG. 9. The directivity of the antenna device 41 according to the present embodiment, that is, in a case where both of the metal plate 42 and the mirror body 6 are provided is compared with a directivity of an antenna device according to a first comparative example and a directivity of an antenna according to a second comparative example.

In the antenna device according to the first comparative example, the metal plate 42 is not disposed between the first antenna 50 and the second antenna 60, and the mirror body 6 is not provided. Thus, as illustrated by the dotted line IXa in FIG. 9, the antenna device can function only as a vertically-polarized phased array antenna and cannot have a gain of the horizontally-polarized wave. In the antenna device according to the second comparative example, although the metal plate 42 is not disposed between the first antenna 50 and the second antenna 60, the mirror body 6 is provided. Thus, as illustrated by the dashed line IXb in FIG. 9, the metal film 7 of the mirror body 6 can function as a horizontally-polarized non-feed element. Therefore, the antenna device according to the second comparative example can have a gain of the horizontally-polarized wave at a high level. In the antenna device according to the present embodiment, both of the metal plate 42 and the mirror body 6 are provided. The function of the metal plate 42 as the horizontally-polarized non-feed element is further increased due to the reflection by the mirror body 6. Thus, as illustrated by the solid line IXc, the antenna device according to the present embodiment can have a gain of horizontally-polarized wave at a level higher than the gain of the second comparative example.

As described above, the room mirror 40 according to the present embodiment includes the antenna device 41. The antenna device 41 includes the first antenna 50, the second antenna 60, and the metal plate 42. Each of the first antenna 50 and the second antenna 60 is the vertically-polarized antenna. The first antenna 50 and the second antenna 60 are apart from each other in the approximately horizontal direction. The metal plate 42 is arranged between the first antenna 50 and the second antenna 60 on the rear side of the ground planes 51 and 61. The metal plate 42 can function as the horizontally-polarized non-feed element for both of the first antenna 50 and the second antenna 60. The phase difference between the signal of the first antenna 50 and the signal of the second antenna 60 are controlled to be the desired amount. Thereby, the polarization plane can be changed between the horizontally-polarized wave and the vertically-polarized wave, and the directivities of each of the polarized wave can be changed in a manner similar to the first embodiment.

Thus, even if an arrival direction and the polarization plane of the received signal are changed, the antenna device 41 can have a high receiving performance. Also at a time of transmitting signal, the antenna device 41 can have effects similar to the time of receiving signal. The first antenna 50 faces the metal plate 42 only at the predetermined section including the feeding point 54 and the other section of the first antenna 50 does not face the metal plate 42. The second antenna 60 faces the metal plate 42 only at a predetermined section including a feeding point 64 and the other section of the second antenna 60 does not face the metal plate 42. Thus, each of the first antenna 50 and the second antenna 60 can have a high gain of the vertically-polarized wave. The first antenna 50 and the second antenna 60 are strongly coupled with each other centering on each of the feeding points 54 and 64, and large horizontal electric current flows in the metal plate 42. Thus, each of the first antenna 50 and the second antenna 60 can have high gain of the horizontally-polarized wave. As a result, the gain of the horizontally-polarized wave of the whole antenna device 41 can be increased.

In the present embodiment, the antenna device 41 is disposed in the mirror housing 3. Thus, the metal plate 42 may be omitted and the metal film 7 of the mirror body 6 may be used as a non-feed element instead of the metal plate 42. In such a case, a dimension of the antenna device 41 can be reduced while keeping the high gain of the vertically-polarized wave and the horizontally-polarized wave.

### Other Embodiments

Although the present invention has been fully described in connection with the preferred embodiments thereof with reference to the accompanying drawings, it is to be noted that various changes and modifications will become apparent to those skilled in the art.

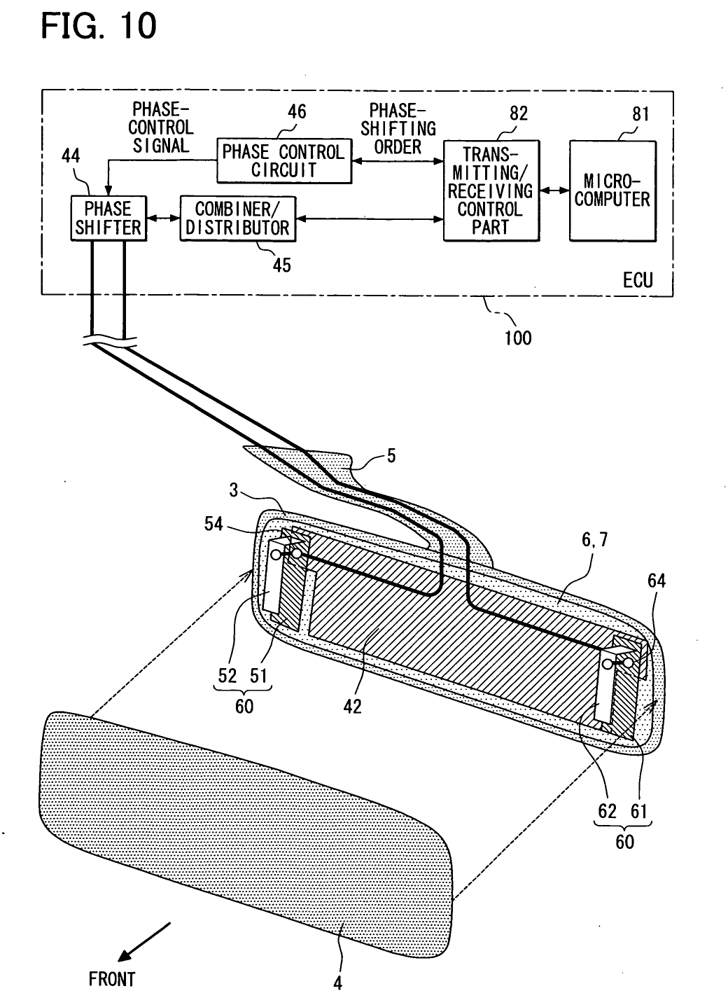

In the second embodiment, the room mirror 40 includes the phase shifter 44, the combiner/distributor 45, and the phase control circuit 46 in addition to the first antenna 50 and the second antenna 60. Alternatively, as illustrated in FIG. 10, the room mirror 40 may include the first antenna 50, the second antenna 60, and the metal plate 42, and an in-vehicle ECU 100 may include the phase shifter 44, the combiner/distributor 45, and the phase control circuit 46.

Alternatively, the room mirror 40 may include the phase shifter 44, and the in-vehicle ECU 100 may include the combiner/distributor 45 and the phase control circuit 46. Components disposed in the mirror housing 3 and components disposed outside the mirror housing 3 are appropriately determined so that the antenna device 41 can have a desired function. Also in the room mirror 1 according to the first embodiment, components disposed in the mirror housing 3 and disposed outside the mirror housing 3 can be determined so that the antenna device 2 can have a desired function.

In the above-described embodiments, the antenna device 2 or the antenna device 41 is disposed in the mirror housing 3, as an example. Each of the antenna device 2 and the antenna device 41 may be coupled with the corresponding room mirror 1 or 40, for example, by fixing each of the antenna device 2 and the antenna device 41 on the front side of the resin cover 4. Alternatively, each of the antenna device 2 and the antenna device 41 may be separated from the corresponding room mirror 1 or 40. For example, each of the antenna device 2 and the antenna device 41 may be disposed in or coupled with other device or a module.

In the first embodiment, each of the first antenna 20 and the second antenna 30 is the inverted F antenna having the plate shape, as an example. Each of the first antenna 20 and the second antenna 30 may have other shape as long as a desired property can be obtained. For example, each of the first antenna 20 and the second antenna 30 may be an inverted L antenna as illustrated in FIG. 11. The inverted L antenna includes a ground plane 71 and an antenna element 72 disposed on the ground plane 71. The antenna element 72 has an inverted L shape. A portion of the ground plane 71 where the antenna element 72 rises becomes a feeding point 73.

Each of the first antenna 20 and the second antenna 30 is not limited to a plate-shape antenna. For example, each of the first antenna 20 and the second antenna 30 may be an inverted F antenna or an inverted L antenna having a line shape. The plate shape antenna is preferable to the line shape antenna in view of matching impedance, forming an antenna element, and a stability of the antenna element fixed to a ground plane. The first antenna 20 and the second antenna 30 may be different types. For example, one of the first antenna 20 and the second antenna 30 may be an inverted F antenna and the other may be an inverted L antenna. The first antenna 50 and the second antenna 60 may be various types of antenna in a manner similar to the first antenna 20 and the second antenna 30.

In the first embodiment, the circuit ground 11 that can function as a horizontally-polarized non-feed element is formed at the whole area of rear surface of the substrate 10 except of the regions corresponding to the ground planes 21 and 31. The circuit ground 11 is not required to be formed at such a wide area. For example, the circuit ground 11 may be a metal pattern having a line shape connecting a portion located adjacent to the feeding point 24 of the first antenna 20 and a portion located adjacent to the feeding point 34 of the second antenna 30. The circuit ground 11 may have various shapes as long as the circuit ground 11 is coupled with the first antenna 20 and the second antenna 30 and can function as the horizontally-polarized non-feed element. The metal plate 42 in the second embodiment may have various shapes as long as the metal plate 42 is coupled with the first antenna 50 and the second antenna 60 and can function as the horizontally-polarized non-feed element.

In the above-described embodiments, each of the phase shifters 12, 13 and 44 is a hybrid phase shifter (reflective variable phase shifter), as an example. Each of the phase shifters 12, 13, and 44 may be other type of phase shifter as long as the phase shifters 12, 13, and 44 can change the phase of the received signal or the phase of the transmitting signal into a desired phase.

In the first embodiment, the two phase shifters 12 and 13 are provided, as an example. Alternatively, only one of the phase shifters 12 and 13 may be provided in a manner similar to the second embodiment. On the other hand, in the second embodiment, the number of phase shifter may be two in a manner similar to the first embodiment. A phase shifter may be provided for each of two antennas or may be provided for one of two antennas as long as the phase shifter can control the phase difference of signals into a desired amount.

In the above-described embodiment, a distance between the metal film 7 and the substrate 10 and a distance between the metal film 7 and the metal plate are set to be about ¼λ. The distances may be shorter than about ¼λ. When each of the distances is longer than about ¼λ, an electric current that flows in a pattern functioning as non-feed element may counteract the reflection wave by the metal film 7.

In the above-described embodiments, each of the antenna device 2 and the antenna device 41 changes the polarization plane and controls the directivity both at a time of receiving a signal and a time of transmitting a signal. Alternatively, each of the antenna device 2 and the antenna device 41 may be configured to change the polarization plane and control the directivity only at one of a time of receiving a signal and a time of transmitting a signal.

What is claimed is:

1. An antenna device for a vehicle, comprising:
a substrate extending in an approximately horizontal direction;
a first antenna and a second antenna disposed at respective horizontal end portions of the substrate, each of the first antenna and the second antenna being a vertically-polarized antenna;
a first ground pattern and a second ground pattern disposed on the substrate, the first ground pattern configured to function as a ground plane of the first antenna, the second ground pattern configured to function as a ground plane of the second antenna;
an intermediate pattern disposed on the substrate and located between the first ground pattern and the second ground pattern, the intermediate pattern configured to function as a horizontally-polarized non-feed element for the first antenna and the second antenna;
a phase control part configured to control a phase difference between a signal of the first antenna and a signal of the second antenna by changing at least one of a phase of the signal of the first antenna and a phase of the signal of the second antenna; and
a combining portion configured to combine the signals after the phase control part controls the phase deference.

2. The antenna device according to claim 1, wherein:
the first ground pattern, the second ground pattern, and the intermediate pattern are formed of one electrically-conductive pattern;
the first ground pattern is located at a first end portion of the electrically-conductive pattern;
the second ground pattern is located at a second end portion of the electrically-conductive pattern;
each of the first antenna and the second antenna has an antenna element;
the antenna element of the first antenna is disposed at the first end portion of the electrically-conductive pattern; and
the antenna element of the second antenna is disposed at the second end portion of the electrically-conductive pattern.

3. The antenna device according to claim 2, wherein:
the substrate is disposed in such a manner that a plate surface of the substrate is approximately vertical to a ground;
the substrate is divided into two equal sections in an approximately vertical direction;
each of the first antenna and the second antenna has a feeding point at one of the sections;
each of the antenna elements includes a vertical element portion having one of a line shape and a plate shape;
the vertical element portion is approximately parallel to the plate surface of the substrate and is approximately vertical to the ground;
the vertical element portion extends from the one of the sections where the feeding points are provided toward the other one of the sections;
each of the first ground pattern and the second ground pattern is apart from the intermediate pattern at least at a region where a distance from the feeding point is greater than a predetermined distance in a direction in which the vertical element portion extends.

4. The antenna device according to claim 2, wherein:
the phase control part include a control-signal output portion and a phase changing portion;
the control-signal output portion outputs a control signal for controlling the phase difference;
the phase changing portion changes the phase based on the control signal from the control-signal output portion; and
a feeding line between the phase changing portion, the combining portion, the first antenna, and the second antenna is formed of a microstrip line on the substrate.

5. The antenna device according to claim 1, wherein:
the vehicle includes a room mirror disposed in a vehicle interior;
the room mirror includes a mirror body and a mirror housing;
the mirror body has a first and second opposing surfaces;
the first surface is a mirror plane;
the second surface has a metal film for reflecting light;
the mirror body is fitted in the mirror housing in such a manner that the mirror plane is exposed to an outside of the mirror housing; and
the antenna device is integrated with the room mirror.

6. The antenna device according to claim 5, wherein:
the antenna device is disposed in the mirror housing; and
the substrate is apart from the metal film and faces the metal film.

7. The antenna device according to claim 1, further comprising
a distributing portion configured to distribute a transmitting signal to the first antenna and the second antenna, wherein
the phase control part controls the phase difference of the transmitting signals by changing at least one of a phase of the transmitting signal of the first antenna and a phase of the transmitting signal of the second antenna.

8. The antenna device according to claim 1, wherein
the phase control part is capable of controlling the phase difference at least to ±90 degrees and ±180 degrees.

9. The antenna device according to claim 1, wherein
each of the first antenna and the second antenna is one of an inverted F antenna and an inverted L antenna.

10. An antenna device for a vehicle, comprising:
a first antenna and a second antenna separated from each other in an approximately horizontal direction, each of the first antenna and the second antenna being a vertically-polarized antenna;
an intermediate conductive member disposed between the first antenna and the second antenna, the intermediate conductive member is configured to function as a horizontally-polarized non-feed element for the first antenna and the second antenna;
a phase control part configured to control a phase difference between a signal of the first antenna and a signal of the second antenna by changing at least one of a phase the signal of the first antenna and a phase of the signal of the second antenna; and
a combining portion configured to combine the signals after the phase control part controls the phase deference.

11. The antenna device according to claim 10, wherein:
the intermediate conductive member has a plate shape;
the intermediate conductive member is disposed in such a manner that a plate surface of the intermediate conductive member is approximately vertical to a ground;
each of the first antenna and the second antenna has a ground plane, an antenna element, and a feeding point;
the ground plane is approximately parallel to the plate surface of the intermediate conductive member;
the antenna element is disposed on the ground plane and is located on an opposite side of the ground plane from the intermediate conductive member; and
the feeding point faces the intermediate conductive member.

12. The antenna device according to claim 11, wherein
the intermediate conductive member is configured so that a predetermined section of each of the first antenna and the second antenna including the feeding point faces the intermediate conductive member and the other section of each of the first antenna and the second antenna is located outside a horizontal end of the intermediate conductive member.

13. The antenna device according to claim 10, wherein
the phase control part includes a control-signal output portion and a phase changing portion;
the control-signal output portion outputs a control signal for controlling the phase difference;
the phase changing portion changes the phase based on the control signal from the control-signal output portion;
each of the phase changing portion and the combining portion is formed of a circuit on a substrate disposed between the first antenna and the second antenna;
the substrate further includes a ground pattern of each of the circuits; and
the intermediate conductive member is the ground pattern.

14. The antenna device according to claim 13, wherein
each of the circuits is formed of a microstrip line on the substrate.

15. The antenna device according to claim 10, wherein:
the vehicle includes a room mirror disposed in a vehicle interior;
the room mirror includes a mirror body and a mirror housing;
the mirror body has a first and second opposing surfaces;
the first surface is a mirror plane;
the second surface has a metal film for reflecting light;
the mirror body is fitted in the mirror housing in such a manner that the mirror plane is exposed to an outside of the mirror housing;
the antenna device is integrated with the room mirror; and
the intermediate conductive member is the metal film of the mirror body.

16. The antenna device according to claim 10, wherein:
the vehicle includes a room mirror disposed in a vehicle interior;
the room mirror includes a mirror body and a mirror housing;
the mirror body has a first and second opposing surfaces;
the first surface is a mirror plane;
the second surface has a metal film for reflecting light;
the mirror body is fitted in the mirror housing in such a manner that the mirror plane is exposed to an outside of the mirror housing;
the antenna device is integrated with the room mirror; and
the intermediate conductive member is apart from the metal film and faces the metal film.

17. The antenna device according to claim 10, further comprising
a distributing portion configured to distribute a transmitting signal to the first antenna and the second antenna, wherein
the phase control part controls the phase difference of the transmitting signals by changing at least one of a phase of the transmitting signal of the first antenna and a phase of the transmitting of the second antenna.

18. The antenna device according to claim 10, wherein
the phase control part is capable of controlling the phase difference at least to ±90 degrees and ±180 degrees.

19. The antenna device according to claim 10, wherein
each of the first antenna and the second antenna is one of an inverted F antenna and an inverted L antenna.
